(19) United States
(12) Patent Application Publication
(10) Pub. No.: US 2009/0224414 A1
(43) Pub. Date: Sep. 10, 2009

(54) EVAPORATIVE HUMIDIFIER

(75) Inventors: Akira YOKOYAMA, Tokyo (JP); Koji SUZUKI, Tokyo (JP); Kosei KAWASAKI, Tokyo (JP)

Correspondence Address: ROBERTS MLOTKOWSKI SAFRAN & COLE, P.C.;Intellectual Property Department, P.O. Box 10064, MCLEAN, VA, 22102-8064, US

(73) Assignee: HITACHI PLANT TECHNOLOGIES, LTD., Tokyo (JP)

(21) Appl. No.: 12/396,070

(22) Filed: Mar. 2, 2009

(30) Foreign Application Priority Data
Mar. 5, 2008 (JP) 2008-054938

(51) Int. Cl. B01F 3/04

(52) U.S. Cl. 261/130; 261/39.1; 261/103; 261/106; 261/DIG. 3; 261/DIG. 43

(57) ABSTRACT

In the evaporative humidifier of the present invention, a desired humidity is obtained by supplying water only to a humidifying module required for humidification. Air simply passes through a humidifying module to which water is not supplied. Accordingly, air obtained by mixing humidified air passing through the humidifying module which is wet with water being supplied thereto (wet zone) and non-humidified air passing through the humidifying module to which water is not supplied (dry zone) is blown out from an outlet of the evaporative humidifier. The mixture amount (mixture ratio) is controlled by the opening and closing of the valve, so that a desired humidity is obtained. Therefore, with the evaporative humidifier of the present invention, humidity control can be accurately performed without unnecessarily operating the humidifying device and without wasting energy.

### BACKGROUND OF THE INVENTION

1. Field of the Invention

The present invention relates to an evaporative humidifier, and more particularly, to an evaporative humidifier which is installed to control temperature and humidity in a precision equipment factory such as a clean room.

2. Description of the Related Art

In the precision equipment factory such as a clean room, it is necessary to keep the temperature and humidity constant. An evaporative humidifier as disclosed in Japanese Patent Application Laid-Open No. 2001-317795 is known as a humidifying apparatus for performing temperature and humidity control in such a room.

The evaporative humidifier includes a heating coil, an evaporative humidifier, a cooling coil, a fan, a dry-bulb temperature sensor, and a dew-point temperature sensor, which are disposed from an air inlet side to an air outlet side of an air flow path formed by a housing.

The evaporative humidifier is composed of a humidifying module in which water is allowed to flow along the surface of a humidifying element such that the surface gets wet by allowing water to seep to the top portion of the humidifying element from a water supply pipe. The evaporative humidifier performs humidification by controlling the heating coil and the cooling coil such that a dew point after humidification detected by the dew-point temperature sensor becomes constant. Also, in the heating coil and the cooling coil, heating and cooling amounts are proportionally controlled based on a dew-point temperature detected by the dew-point temperature sensor.

FIG. 6 shows a general configuration of a conventional evaporative humidifier. In the evaporative humidifier 1, an air inlet 2A is formed on the upstream side of an air flow path 2 that is formed by a housing, and an air outlet 2B for air whose temperature and humidity are regulated is formed on the downstream side of the air flow path 2. A heating/cooling coil 3, a humidifying element 4, and a dew-point meter 5 are disposed in the air flow path 2 from the upstream side to the downstream side thereof. The opening and closing of a control valve of the heating/cooling coil 3 is controlled based on the dew-point temperature detected by the dew-point meter 5, so as to control the heating and cooling amounts.

Humidification amount control in the evaporative humidifier 1 is performed by controlling the temperature of inlet air flowing in from the air inlet 2A by the heating/cooling coil 3. FIG. 7 shows a psychrometric chart showing a control method thereof. In FIG. 7, it is shown that the temperature of the inlet air is heated and the heated air humidified, so that the air is controlled to have a target humidity.

### SUMMARY OF THE INVENTION

However, the method of controlling a humidification amount shown in FIG. 7 has such a problem that when a humidifier to be attached to an outside air conditioner is assumed, the humidifier is very difficult to control in the intermediate season such as spring or autumn in which the humidity of air around the inlet is close to the target humidity since the evaporative humidifier 1 has only ON/OFF control.

That is, if the inlet humidity (initial value) is 40% when a targeted relative humidity is 50% as shown in FIG. 8, the humidifier is turned ON, and humidification is performed in large amounts. As a result, the humidity of outlet air largely exceeds 50%, and thus, the humidifier is turned OFF. Soon after a short period of time, the humidity around the dew-point meter returns to 40% that is the humidity of outside air, and the humidifier is turned ON again. As described above, in the intermediate season in which a difference between the target humidity and the humidity of outside air is small, the humidifier is alternately turned ON/OFF with frequency as shown in FIG. 8, and the humidifier is thereby unnecessarily operated, which is not preferable.

As a first solution to solve the problem, the sensor sensitivity of the control valve of the humidifier may be lowered. Accordingly, the humidifier is not turned ON even if the humidity is low to a certain extent, so that the humidity value is prevented from fluctuating up and down due to the ON/OFF control.

However, in the case of the first solution, once the humidifier is turned ON, humidification is performed in substantial amounts. Thus, the control cannot be considered as appropriate control.

On the other hand, as a second solution, a method of excessively heating the inlet air (outside air) more than normal first, humidifying the air, and subsequently, dehumidifying and cooling the humidified high-temperature air by the cooling coil, so as to control the air to have the target humidity may be employed as shown in a psychrometric chart in FIG. 9. According to the control method, there is such an advantage that accurate control is enabled since the control by cooling is easier than the control by heating and humidification.

However, the second solution has such a disadvantage that the running cost is increased since a great deal of energy is required for the excess heating.

The present invention has been made in view of such circumstances, and it is an object of the present invention to provide an evaporative humidifier capable of accurately performing humidity control without unnecessarily operating a humidifying device and without wasting energy.

In order to achieve the above object, the present invention provides an evaporative humidifier which humidifies air by allowing the air to pass through a humidifying element of a humidifying device, comprising: a plurality of humidifying modules which is formed by dividing the humidifying element via a partition member; a water supply device with a valve which is provided in each of the divided humidifying modules; and a control device which controls opening and closing of the valve with respect to each device.

In the present invention, a desired humidity is obtained by supplying water only to a humidifying module required for humidification. Air simply passes through a humidifying module to which water is not supplied. Accordingly, air obtained by mixing humidified air passing through the humidifying module which is wet with water being supplied thereto (wet zone) and non-humidified air passing through the humidifying module to which water is not supplied (dry zone) is blown out from an outlet of the evaporative humidifier. The mixture amount (mixture ratio) is controlled by the opening and closing of the valve, so that a desired humidity is obtained. Therefore, with the evaporative humidifier of the present invention, humidity control can be accurately performed without unnecessarily operating the humidifying device and without wasting energy.

Also, according to the present invention, the humidifying element is preferably formed into a rectangular shape in section so as to have the same thickness with respect to an air passing direction, or into a substantially triangular shape in section so as to have a gradually changing thickness with respect to the air passing direction.

With the present invention, by forming the humidifying element into the rectangular shape in section, the humidity proportionally rises or falls in accordance with the number of humidifying modules to which water is supplied. Also, by forming the humidifying element into the substantially triangular shape in section, the humidity rises or falls in a curve in accordance with the number of humidifying modules to which water is supplied. The humidifying elements are selected according to a humidity environment of outside air introduced into the evaporative humidifier.

Furthermore, according to the present invention, a dew-point detecting device which detects a dew point of the air passing through the humidifying device is preferably provided, wherein the control device controls the opening and closing of the valve with respect to each valve based on the dew point detected by the dew-point detecting device.

With the present invention, the control device feedback-controls the opening and closing of the valve with respect to each valve based on the dew point detected by the dew-point detecting device, so that a desired humidity can be obtained.

Moreover, the present invention preferably further comprises a heating/cooling device which heats/cools the air, wherein a heating amount by the heating/cooling device is controlled to obtain air having a desired temperature.

Accordingly, with the evaporative humidifier of the present invention, the air having a desired temperature and humidity can be supplied into a room.

As described above, according to the evaporative humidifier of the present invention, humidity control can be accurately performed without unnecessarily operating the humidifier and without wasting energy.

### BRIEF DESCRIPTION OF THE DRAWINGS

FIG. 1 is a block diagram showing a configuration of an evaporative humidifier according to an embodiment;

FIG. 2 is a perspective view showing a configuration of a humidifying device according to a first embodiment;

FIG. 3 is a perspective view showing a configuration of a humidifying device according to a second embodiment;

FIG. 4 is a perspective view showing a configuration of a humidifying device according to a third embodiment;

FIG. 5 is a graph showing an increase in humidity relative to a degree of opening of a water supply electromagnetic valve;

FIG. 6 is a block diagram showing a general configuration of a conventional evaporative humidifier;

FIG. 7 is a psychrometric chart for explaining one example of a method of controlling a humidification amount in a conventional evaporative humidifier;

FIG. 8 is a view serially showing ON/OFF of a humidifier when a target humidity is 50%; and

FIG. 9 is a psychrometric chart for explaining one example of a method of controlling a humidification amount in a conventional evaporative humidifier.

### DETAILED DESCRIPTION OF THE PREFERRED EMBODIMENTS

In the following, preferable embodiments of an evaporative humidifier according to the present invention will be described in detail with reference to the accompanying drawings.

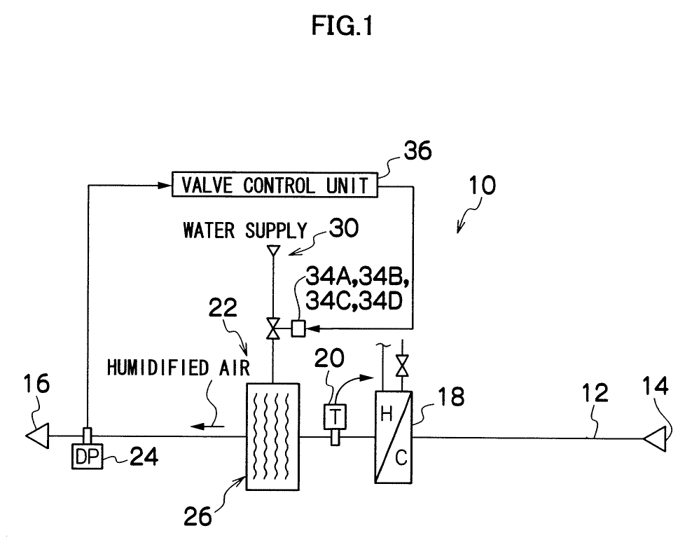

FIG. 1 is a block diagram showing a configuration of an evaporative humidifier 10 according to an embodiment.

The evaporative humidifier 10 shown in FIG. 1 includes a humidification flow path 12 formed by a housing case. An air inlet 14 for introducing outside air and an air outlet 16 for discharging conditioned air whose temperature and humidity are regulated into a room are formed at the ends of the humidification flow path 12. A cooling/heating coil 18 is provided on the upstream side of the humidification flow path 12. Air (outside air) flowing in the humidification flow path 12 is cooled or heated to a desired temperature by a cooling/heating medium supplied to the cooling/heating coil 18.

A thermometer 20 is provided on the downstream side of the humidification flow path 12 from the cooling/heating coil 18. The temperature of air passing through the cooling/heating coil 18 is measured by the thermometer 20. The amount or temperature of the cooling/heating medium to be supplied to the cooling/heating coil 18 is feedback-controlled by an unillustrated control device based on the measured air temperature. A humidifying device 22 according to a first embodiment is provided on the downstream side of the humidification flow path 12 from the thermometer 20. Also, a dew-point meter (dew-point detecting device) 24 is provided on the downstream side of the humidification flow path 12 from the humidifying device 22.

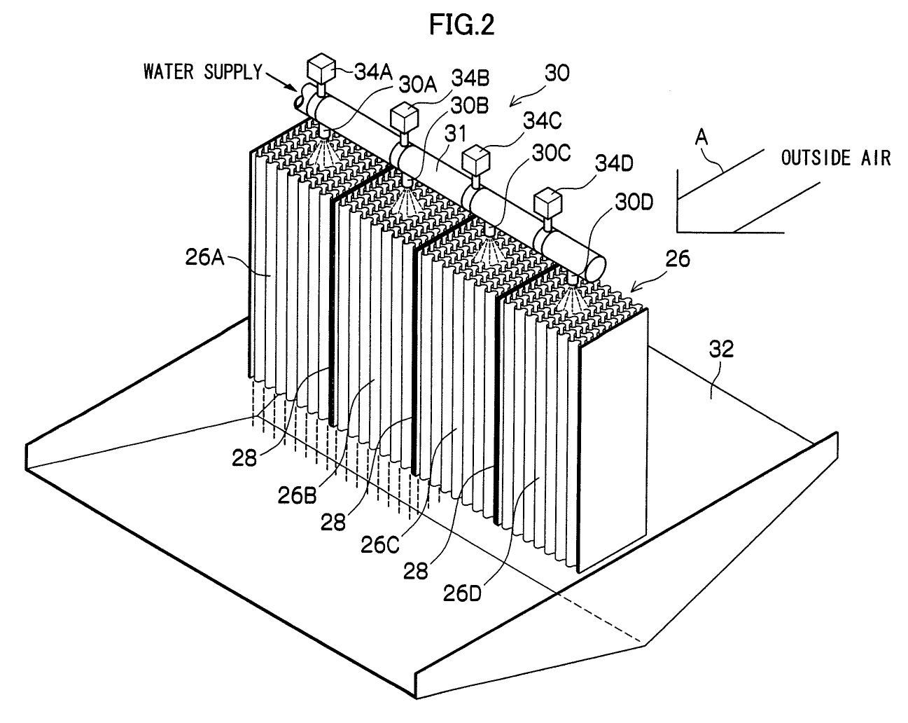

A humidifying element 26 which constitutes the humidifying device 22 according to the first embodiment is disposed in a direction perpendicular to a flow direction A of the introduced outside air as shown in FIG. 2. The humidifying element 26 is formed into a rectangular shape in section along the outside air flow direction A, and has the same thickness over the entire area. Furthermore, the humidifying element 26 is divided in the vertical direction into four humidifying modules 26A, 26B, 26C, and 26D. The adjacent humidifying modules 26A to 26D are divided by separators (partition members) 28, so that water does not enter from the adjacent humidifying modules 26A to 26D. The division number of the humidifying element 26 is not limited to four, and the humidifying element 26 may be divided into two or more humidifying modules. However, by dividing the humidifying element 26 into a plurality of humidifying modules, humidity control described below will be precisely performed.

A water supply unit 30 which constitutes the humidifying device 22 includes four nozzles 30A, 30B, 30C, and 30D which respectively supply water to the humidifying modules 26A, 26B, 26C, and 26D. The surfaces of the humidifying modules 26A to 26D get wet by allowing water to seep from the nozzles 30A to 30D, and air flowing in the humidification flow path 12 is allowed to pass through the humidifying modules 26A to 26D, so as to perform humidification. Extra water dropping from the humidifying modules 26A to 26D is collected in a drain pan 32 located below the humidifying element 26.

In a water supply pipe 31 on which the nozzles 30A to 30D of the water supply unit 30 are provided, water supply electromagnetic valves (valves) 34A, 34B, 34C, and 34D are provided corresponding to the nozzles 30A, 30B, 30C, and 30D. That is, when the water supply electromagnetic valve 34A on the upstream side is opened in response to water supply, water is supplied to the humidifying module 26A from the nozzle 30A. When the water supply electromagnetic valves 34A and 34B are opened, water is supplied to the humidifying modules 26A and 26B from the nozzles 30A and 30B. Similarly, when the water supply electromagnetic valves 34A to 34C are opened, water is supplied to the humidifying modules 26A to 26C from the nozzles 30A to 30C, and when the water supply electromagnetic valves 34A to 34D are opened, water is supplied to the humidifying modules 26A to 26D from the nozzles 30A to 30D. In other words, by controlling the opening and closing of the water supply electromagnetic valves 34A to 34D, the humidifying module to which water is to be supplied is selected from the humidifying modules 26A to 26D. Accordingly, the humidifying module which gets wet with water (wet zone) and the humidifying module to which water is not supplied (dry zone) are formed in one humidifying element 26.

On the other hand, the opening and closing of the water supply electromagnetic valves 34A to 34D is controlled by a valve control unit 36 shown in FIG. 1. The valve control unit 36 controls the opening and closing of the water supply electromagnetic valves 34A to 34D such that a desired humidity is obtained based on a dew point detected by the dew-point meter 24.

That is, in the evaporative humidifier 10 according to the embodiment, a desired humidity is obtained by supplying water only to the humidifying module required for humidification in the humidifying element 26. Air simply passes through the humidifying module to which water is not supplied. Therefore, air obtained by mixing humidified air passing through the humidifying module which gets wet with water being supplied thereto (wet zone) and non-humidified air passing through the humidifying module to which water is not supplied (dry zone) is blown out from the outlet 16 of the evaporative humidifier 10. The mixture amount (mixture ratio) is controlled by the opening and closing of the water supply electromagnetic valves 34A to 34D, so as to obtain a desired humidity. To be more specific, the valve control unit 36 feedback-controls the opening and closing of each of the water supply electromagnetic valves 34A to 34D based on the dew point detected by the dew-point meter 24, so that a desired humidity can be obtained.

As described above, according to the evaporative humidifier 10 of the embodiment, the humidifying device 22 maintains a stable ON state to perform humidity regulation. Therefore, the humidifying device 22 is not unnecessarily operated in comparison with a humidifying device which is frequently turned ON/OFF as in a conventional case, and energy is not wasted since excess heating by the cooling/heating coil 18 is not required. Since the mixture ratio of the humidified air and non-humidified air is controlled to perform humidity regulation, humidity control can be accurately performed.

Also, according to the evaporative humidifier 10 of the embodiment, the amount or temperature of the cooling/heating medium to be supplied to the cooling/heating coil 18 is controlled by the unillustrated control device based on the air temperature measured by the thermometer 20 such that the air has a desired temperature. Accordingly, the air having a desired temperature and humidity can be supplied into a room according to the evaporative humidifier 10.

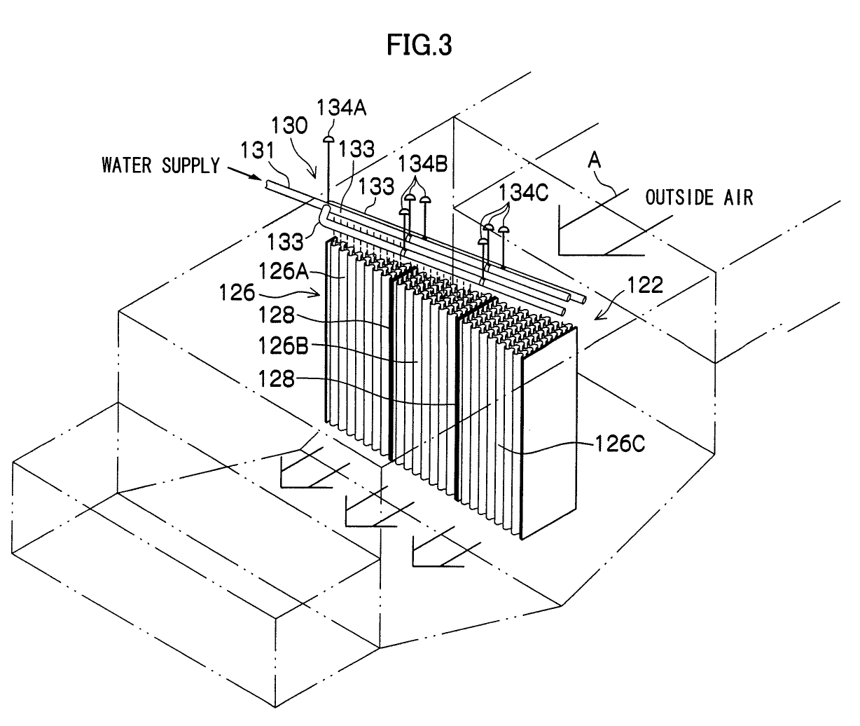

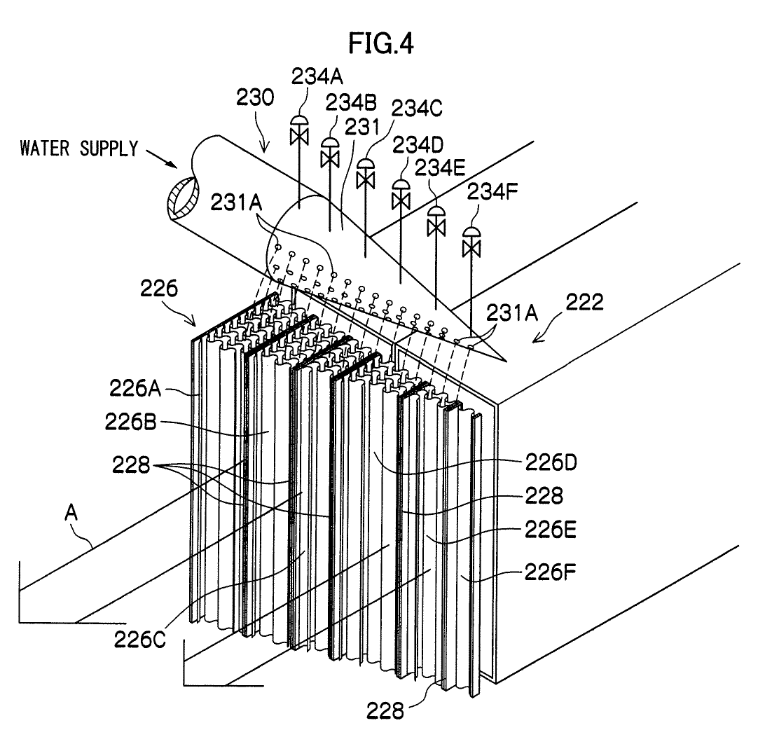

FIG. 3 and FIG. 4 respectively show a humidifying device 122 according to a second embodiment, and a humidifying device 222 according to a third embodiment.

Humidifying elements 126 and 226 of the humidifying devices 122 and 222 are formed into a substantially triangular shape in section so as to have a gradually changing thickness with respect to the air passing direction A.

The humidifying element 126 shown in FIG. 3 is formed to become gradually thicker from the upstream side to the downstream side in a water supply direction. The humidifying element 226 shown in FIG. 4 is formed to become gradually thinner from the upstream side to the downstream side in the water supply direction.

The humidifying element 126 shown in FIG. 3 is divided in the vertical direction into three humidifying modules 126A, 126B, and 126C. The adjacent humidifying modules 126A to 126C are divided by separators 128. Also, the humidifying element 226 shown in FIG. 4 is divided in the vertical direction into six humidifying modules 226A, 226B, 226C, 226D, 226D, 226E and 226F. The adjacent humidifying modules 226A to 226F are divided by separators 228. The division numbers of the humidifying elements 126 and 226 are not limited to the above numbers.

A water supply unit 130 of the humidifying device 122 in FIG. 3 includes three water supply pipes 133 coupled to a main pipe 131. A plurality of injection holes (not shown) are formed in the bottom portions of the water supply pipes 133 such that water is injected from the injection holes to the humidifying modules 126A to 126C. Also, a single water supply electromagnetic valve 134A is provided at the base portion of the water supply pipes 133. Water supply electromagnetic valves 134B are respectively provided on the upstream sides of the water supply pipes 133, and water supply electromagnetic valves 134C are respectively provided on the downstream sides of the water supply pipes 133.

Therefore, when the water supply electromagnetic valve 134A is opened, water is injected from the injection holes formed in the respective water supply pipes 133 between the water supply electromagnetic valve 134A and the respective water supply electromagnetic valves 134B, and water is thereby supplied to the humidifying module 126A of the humidifying element 122. When the water supply electromagnetic valve 134A and the respective water supply electromagnetic valves 134B are opened, water is injected from the injection holes formed in the respective water supply pipes 133 between the water supply electromagnetic valve 134A and the respective water supply electromagnetic valves 134C, and water is thereby supplied to the humidifying modules 126A and 126B of the humidifying element 122. Furthermore, when the water supply electromagnetic valve 134A, the respective water supply electromagnetic valves 134B and the respective water supply electromagnetic valves 134C are opened, water is injected from the injection holes formed in all the water supply pipes 133, and water is thereby supplied to the humidifying modules 126A to 126C of the humidifying element 122. That is, by controlling the opening and closing of the water supply electromagnetic valves 134A to 134C, the humidifying module to which water is to be supplied is selected from the humidifying modules 126A to 126C. Accordingly, the humidifying module which gets wet with water (wet zone) and the humidifying module to which water is not supplied (dry zone) are formed in one humidifying element 126. The opening and closing of the water supply electromagnetic valves 134A to 134C is controlled by a valve control unit (not shown in FIG. 3) in a similar manner to FIG. 1. The valve control unit controls the opening and closing of the water supply electromagnetic valves 134A to 134C based on the dew point detected by the dew-point meter 24 such that a desired humidity is obtained in a similar manner to FIG. 1. In the humidifying device 122 according to the second embodiment, water is also supplied only to the humidifying module required for humidification in the humidifying element 126, so as to obtain a desired humidity.

A water supply unit 230 of the humidifying device 222 in FIG. 4 includes a conical pipe 231 having injection holes 231 A formed in its bottom portion. Water is injected from the injection holes 23IA to the humidifying modules 226A to 226F. Also, water supply electromagnetic valves 234A, 234B, 234C, 234D, 234E and 234F are provided at predetermined intervals from the upstream side to the downstream side of the conical pipe 231. The water supply electromagnetic valves 234A to 234F are located at positions corresponding to the humidifying modules 226A to 226F as described below.

That is, when the water supply electromagnetic valve 234A is opened, water is injected from the injection holes 231A formed in the conical pipe 231 between the water supply electromagnetic valve 234A and the water supply electromagnetic valve 234B, and water is thereby supplied to the humidifying module 226A of the humidifying element 222. When the water supply electromagnetic valves 234A and 234B are opened, water is injected from the injection holes 231A between the water supply electromagnetic valve 234A and the water supply electromagnetic valve 234C, and water is thereby supplied to the humidifying modules 226A and 226B. Furthermore, when the water supply electromagnetic valves 234A to 234C are opened, water is injected from the injection holes 231A between the water supply electromagnetic valve 234A and the water supply electromagnetic valve 234D, and water is thereby supplied to the humidifying modules 226A to 226C. Similarly, when the water supply electromagnetic valves 234A to 234D are opened, water is injected from the injection holes 231A between the water supply electromagnetic valve 234A and the water supply electromagnetic valve 234E, and water is thereby supplied to the humidifying modules 226A to 226D, and when the water supply electromagnetic valves 234A to 234E are opened, water is injected from the injection holes 231A between the water supply electromagnetic valve 234A and the water supply electromagnetic valve 234F, and water is thereby supplied to the humidifying modules 226A to 226E. Finally, when all the water supply electromagnetic valves 234A to 234F are opened, water is injected from all the injection holes 231A of the conical pipe 231, and water is thereby supplied to the humidifying modules 226A to 226F.

That is, by controlling the opening and closing of the water supply electromagnetic valves 234A to 234F, the humidifying module to which water is to be supplied is selected from the humidifying modules 226A to 226F. Accordingly, the humidifying module which gets wet with water (wet zone) and the humidifying module to which water is not supplied (dry zone) are formed in one humidifying element 226. The opening and closing of the water supply electromagnetic valves 234A to 234F is controlled by a valve control unit (not shown in FIG. 4) in a similar manner to FIG. 1. The valve control unit controls the opening and closing of the water supply electromagnetic valves 234A to 234F based on the dew point detected by the dew-point meter 24 such that a desired humidity is obtained in a similar manner to FIG. 1. In the humidifying device 222 according to the third embodiment, water is also supplied only to the humidifying module required for humidification in the humidifying element 226, so as to obtain a desired humidity.

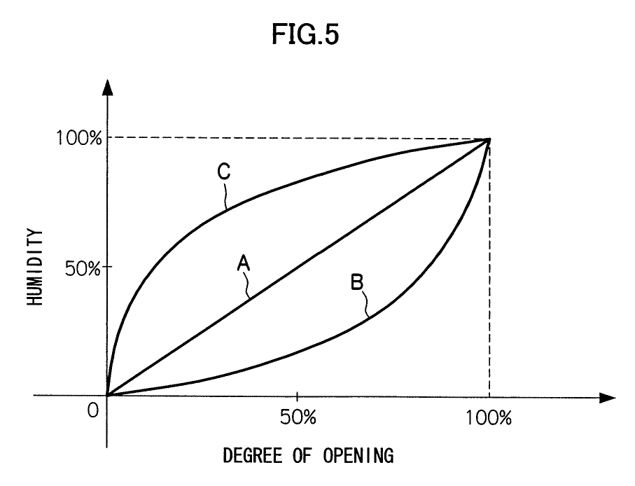

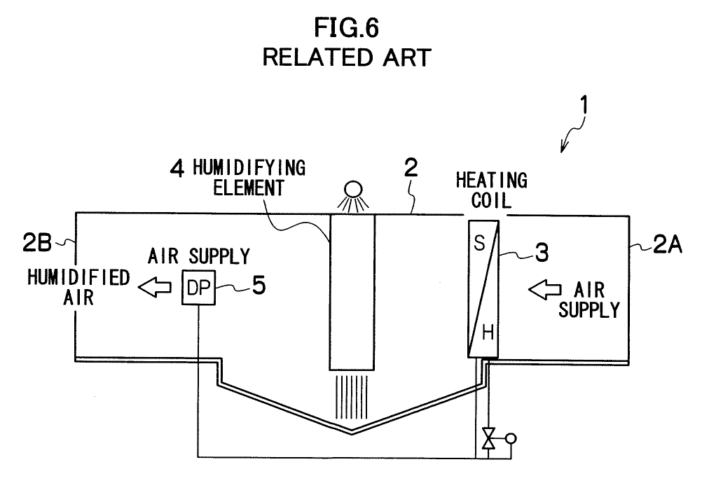

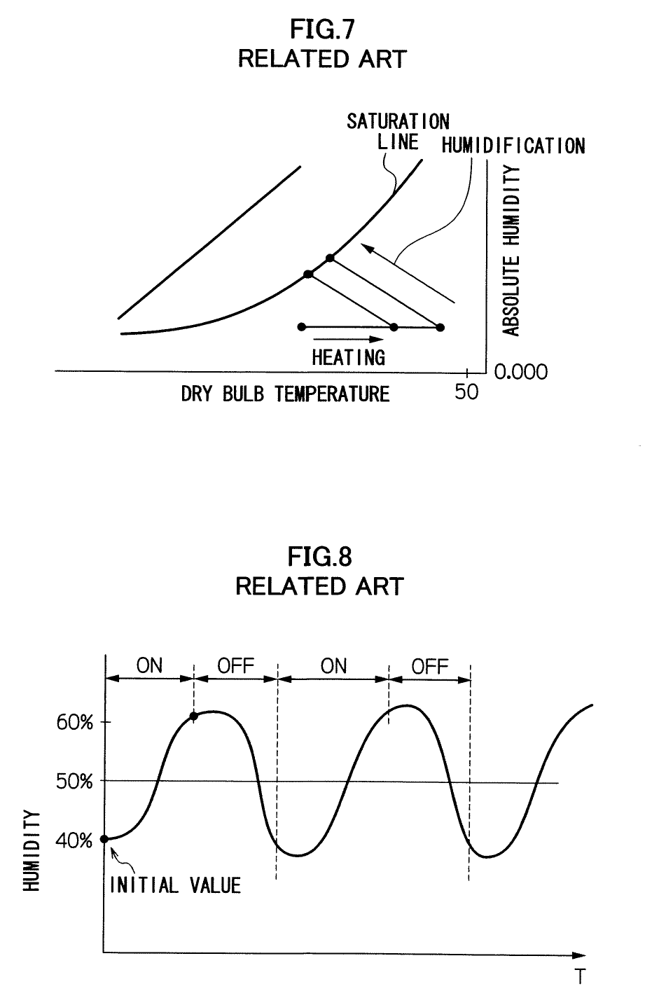

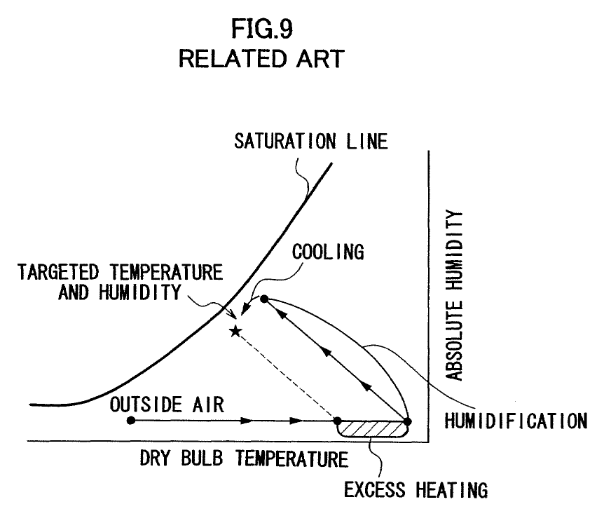

Next, a graph shown in FIG. 5 will be described.

In the graph, the vertical axis represents a humidity around the outlet, and the horizontal axis represents a degree of opening of the water supply electromagnetic valve that is opened. To describe the degree of opening with reference to the humidifying element 26 including the four water supply electromagnetic valves 34A to 34D shown in FIG. 2, for example, the degree of opening is 25% when only the water supply electromagnetic valve 34A is opened, 50% when the water supply electromagnetic valves 34A and 34B are opened, 75% when the water supply electromagnetic valves 34A to 34C are opened, and 100% when all the water supply electromagnetic valves 34A to 34D are opened.

The line A in the graph represents the humidifying element 26 shown in FIG. 2, the line B the humidifying element 126 shown in FIG. 3, and the line C the humidifying element 226 shown in FIG. 4.

Since the humidifying element 26 shown in FIG. 2 has the uniform thickness, the degree of opening is directly reflected in a surface area ratio of the wet and non-wet humidifying modules, and the ratio is reflected as the humidity of the outlet. Therefore, the rate of humidity increase rises in proportion to the degree of opening in comparison with the humidifying elements 126 and 226 shown in FIGS. 3 and 4.

On the other hand, the increases in the humidifying elements 126 and 226 shown in FIGS. 3 and 4 are changed in a curve as in the lines B and C due to a difference in the thickness of the humidifying module. For example, in the case of the humidifying element 126 in FIG. 3, when the degree of opening is small, a small amount of low-humidity air passing through the wet zone and a large amount of air passing through the dry zone are mixed, so that the air has a low humidity. As the degree of opening is larger, the thickness of the humidifying element 126 is larger, and the air has a higher humidity. In the case of the humidifying element 226 in FIG. 4, an effect opposite to that of the humidifying element 126 in FIG. 3 is obtained.

In the case of the humidifying element 26 in FIG. 2, the humidity can be proportionally and gradually controlled by reducing the size of the evaporative humidifier. Also, since the amount of water used is decreased, the running cost can be also reduced.

Also, according to the humidifying elements 126 and 226 shown in FIGS. 3 and 4, the humidity can be proportionally and gradually controlled in a more compact and accurate manner than the humidifying element 26 in FIG. 2. The humidifying element 126 in FIG. 3 is useful in a case where the evaporative humidifier is controlled in an environment in which outside air has a low humidity, and the humidifying element 226 in FIG. 4 is useful in a case where the evaporative humidifier is controlled in an environment in which outside air has a high humidity.

What is claimed is:

1. An evaporative humidifier which humidifies air by allowing the air to pass through a humidifying element of a humidifying device, comprising:
a plurality of humidifying modules which is formed by dividing the humidifying element via a partition member;
a water supply device with a valve which is provided in each of the divided humidifying modules; and
a control device which controls opening and closing of the valve with respect to each device.

2. The evaporative humidifier according to claim 1, wherein
the humidifying element is formed into a rectangular shape in section so as to have the same thickness with respect to an air passing direction, or into a substantially triangular shape in section so as to have a gradually changing thickness with respect to the air passing direction.

3. The evaporative humidifier according to claim 1, further comprising a dew-point detecting device which detects a dew point of the air passing through the humidifying device, wherein
the control device controls the opening and closing of the valve with respect to each valve based on the dew point detected by the dew-point detecting device.

4. The evaporative humidifier according to claim 2, further comprising a dew-point detecting device which detects a dew point of the air passing through the humidifying device, wherein
the control device controls the opening and closing of the valve with respect to each valve based on the dew point detected by the dew-point detecting device.

5. The evaporative humidifier according to claim 1, further comprising a heating/cooling device which heats/cools the air, wherein
a heating amount by the heating/cooling device is controlled to obtain air having a desired temperature.

6. The evaporative humidifier according to claim 2, further comprising a heating/cooling device which heats/cools the air, wherein
a heating amount by the heating/cooling device is controlled to obtain air having a desired temperature.

7. The evaporative humidifier according to claim 3, further comprising a heating/cooling device which heats/cools the air, wherein
a heating amount by the heating/cooling device is controlled to obtain air having a desired temperature.

8. The evaporative humidifier according to claim 4, further comprising a heating/cooling device which heats/cools the air, wherein
a heating amount by the heating/cooling device is controlled to obtain air having a desired temperature.
